(19) United States
(12) Patent Application Publication
(10) Pub. No.: US 2026/0367013 A1
(43) Pub. Date: Nov. 19, 2026

(54) VISUAL INSPECTION OF DRUG PACKAGING USING LED LIGHT

(71) Applicant: Regeneron Pharmaceuticals, Inc., Tarrytown, NY (US)

(72) Inventors: Mark Buckley, Ballston Lake, NY (US); James K. Williams, Watervliet, NY (US); Jason Castle, Esperance, NY (US)

(21) Appl. No.: 19/673,013

(22) Filed: May 11, 2026

Related U.S. Application Data
(60) Provisional application No. 63/808,338, filed on May 19, 2025.
(60) Provisional application No. 63/887,247, filed on Sep. 24, 2025.

(51) Int. Cl. G01N 21/88; G01N 21/84; G01N 21/958

(52) U.S. Cl. CPC G01N 21/8806; G01N 21/958; G01N 2021/845; G01N 2021/8832; G01N 2021/8845; G01N 2201/062

(57) ABSTRACT

Methods and systems are described herein for inspecting a drug package, including illuminating the drug package using a light-emitting diode (LED) light source; and visually inspecting the drug package to determine a presence or an absence of a crack or defect therein, wherein illumination from the LED light source increases visibility of any cracks present in the drug package compared to ambient light.

### CROSS REFERENCE TO RELATED APPLICATIONS

The instant patent application claims priority to U.S. Provisional Patent Application No. 63/808,338, filed May 19, 2025; and U.S. Provisional Patent Application No. 63/887,247, filed Sep. 24, 2025, each of which is incorporated by reference as though fully set forth herein.

### FIELD OF THE DISCLOSURE

Various embodiments of the disclosure relate to methods and systems for inspecting drug packaging, e.g., primary containers such as syringes and vials. More particularly, the disclosure relates to detection of defects, e.g., cracks in drug packaging using LED light.

### INTRODUCTION

Drug packaging, including primary packaging or primary containers such as vials and syringes, e.g., pre-filled syringes, may be visually inspected at various points, including following manufacturing and following fill processes, in order to confirm integrity of the packaging and to deliver pharmaceutical products to end users, e.g., physicians or patients, in sterile packaging that is free from defects. During the visual inspection, any packaging, e.g. vials or syringes, found to contain defects or cracks may be removed from production and destroyed. The visual inspection may typically be performed by a human operator in ambient light conditions. Under these conditions, small defects including cracks (e.g., measured in millimeters) may be difficult to identify, potentially allowing cracked or defective pharmaceutical packaging to pass inspection, and inadvertently proceed toward delivery to an end user. Such defects may result in catastrophic device failure upon attempted use by an end user, and the potential for injury to the user.

In addition to the difficulties of visually identifying small defects in vials and syringes, drug packaging such as pre-filled syringes and vials may also include a label identifying the contents of the packaging including, e.g., proprietary name of the drug product contained therein, the drug product's generic name, dosage, lot number, expiration date, and/or other identifying information. The label may be adhered to an outer surface of the drug packaging, and may further obstruct an inspector's view of the packaging itself, e.g., the vial or syringe. Additionally, pre-filled syringes may be finished, i.e. fully assembled, including a plunger disposed at least partially within the barrel of the pre-filled syringe. This may further reduce the likelihood of positively identifying a crack or defect in the drug packaging, particularly under typical ambient light conditions.

Accordingly, systems and methods are needed to enable detection of cracks or defects in drug packaging, including those having labels disposed thereon.

### SUMMARY

A first aspect of the disclosure provides a method of inspecting a drug package comprising illuminating the drug package using a light-emitting diode (LED) light source; and visually inspecting the drug package to determine a presence or an absence of a crack or defect therein, wherein illumination from the LED light source increases visibility of any cracks present in the drug package compared to ambient light.

In certain embodiments, the drug package comprises glass or a polymer material, e.g., cyclic olefin copolymer (COC) or cyclic olefin polymer (COP).

In certain embodiments, the drug package comprises primary packaging for a drug product (e.g., primary container) and further comprises an ampoule, a cartridge, a vial or a syringe, which may include a plunger at least partially disposed within a barrel thereof.

In certain embodiments, the drug package further comprises a label disposed thereon, which may be substantially opaque, transparent, or translucent.

In certain embodiments, the LED light source comprises white light, green light, or infrared light.

Certain embodiments further comprise illuminating the drug package by backlighting the drug package with the LED light source, which may be, e.g., a light box.

Certain embodiments further comprise illuminating the drug package by axially illuminating the drug package with the LED light source, which may be, e.g., a light bar.

Certain embodiments further comprise using a camera to acquire an image of the drug package under illumination from the LED light source; visually inspecting the drug package by processing the image on a computing device; and processing the image using a machine learning algorithm.

Certain embodiments further comprise inspecting a plurality of drug packages in a batch, wherein the plurality of drug packages are disposed in a clear tray; and conveying the drug package or packages past the LED light source using a conveyor belt.

These and other aspects, advantages, and salient features of the disclosure will become apparent from the following detailed description, which, when taken in conjunction with the annexed drawings, disclose embodiments of the invention.

### BRIEF DESCRIPTION OF THE DRAWINGS

The accompanying drawings, which are incorporated into and constitute a part of this specification, illustrate various exemplary embodiments and, together with the description, serve to explain the principles of the disclosed embodiments. The drawings show different aspects of the present disclosure. Where appropriate, reference numerals illustrating like structures, components, materials, and/or elements in different figures are labeled similarly. It is understood that various combinations of the structures, components, and/or elements, other than those specifically shown, are contemplated and are within the scope of the present disclosure.

The embodiments described herein are not limited to any combinations and/or permutations of such aspects and/or embodiments. Moreover, each of the aspects of the described inventions, and/or embodiments thereof, may be employed alone or in combination with one or more of the other aspects of the described inventions and/or embodiments thereof. For the sake of brevity, certain permutations and combinations are not discussed and/or illustrated separately herein. Notably, an embodiment or implementation described herein as “exemplary” is not to be construed as preferred or advantageous, for example, over other embodiments or implementations; rather, it is intended reflect or indicate the embodiment(s) is/are “example” embodiment(s).

FIGS. 1A and 1B illustrate a cracked glass syringe under ambient light (FIG. 1A) and under green LED light (FIG. 1B) in accordance with some embodiments.

FIGS. 2A and 2B illustrate a cracked glass syringe in a blister package under ambient light (FIG. 2A) and under green LED light (FIG. 2B) in accordance with some embodiments.

FIGS. 3A and 3B illustrate a cracked glass syringe in a blister package under ambient light (FIG. 3A) and under green LED light (FIG. 3B) in accordance with some embodiments.

FIGS. 4A and 4B illustrate a cracked glass syringe in a blister package under ambient light (FIG. 4A) and under green LED light (FIG. 4B) in accordance with some embodiments.

FIG. 5 illustrates a plurality of glass syringes backlit with white light by a lightbox, in accordance with some embodiments.

FIG. 6 illustrates a plurality of glass syringes axially lit with green light, in accordance with some embodiments.

FIG. 7 illustrates a plurality of glass syringes backlit with white light by a lightbox, in accordance with some embodiments.

FIG. 8 illustrates a plurality of glass syringes axially lit with green light, in accordance with some embodiments.

FIGS. 9A and 9B depict glass syringes, each disposed in a finger flange puck, illuminated with a green LED light in accordance with some embodiments.

FIG. 10 illustrates a glass syringe disposed in a finger flange puck and axially illuminated with a green light lightbar at lowest power output at a distance of about 2 inches from the proximal end of the finger flange puck, in accordance with some embodiments.

FIG. 11 illustrates a glass syringe disposed in a finger flange puck and axially illuminated with a green light lightbar at lowest power output at a distance of about 8 inches from the proximal end of the finger flange puck, in accordance with some embodiments.

FIG. 12 illustrates a glass syringe disposed in a finger flange puck and axially illuminated with a green light lightbar at medium power output at a distance of about 2 inches from the proximal end of the finger flange puck, in accordance with some embodiments.

FIG. 13 illustrates a glass syringe disposed in a finger flange puck and axially illuminated with a green light lightbar at medium power output at a distance of about 8 inches from the proximal end of the finger flange puck, in accordance with some embodiments.

FIG. 14 illustrates a glass syringe disposed in a finger flange puck and axially illuminated with a green light lightbar at high power output at a distance of about 2 inches from the proximal end of the finger flange puck, in accordance with some embodiments.

FIG. 15 illustrates a glass syringe disposed in a finger flange puck and axially illuminated with a green light lightbar at high power output at a distance of about 8 inches from the proximal end of the finger flange puck, in accordance with some embodiments.

FIG. 16 illustrates a plurality of glass syringes disposed in a clear tray and axially illuminated with a green lightbar, in accordance with some embodiments.

FIGS. 17A and 17B illustrate exemplary lab benchtop setups for performing syringe crack detection using an infrared (IR) lightbar (FIG. 17A) and a green LED lightbar (FIG. 17B), in accordance with various embodiments.

FIGS. 18A and 18B illustrate a control glass syringe and a cracked glass syringe, respectively, illuminated with IR light (850 nm) from a lightbar, in accordance with various embodiments.

FIGS. 19A and 19B illustrate a control glass syringe and a cracked glass syringe, respectively, illuminated with green light (530 nm) from a lightbar, in accordance with various embodiments.

FIGS. 20A and 20B illustrate a control glass syringe and a cracked glass syringe, respectively, illuminated with IR light (850 nm) from a lightbar, in accordance with various embodiments.

FIGS. 21A and 21B illustrate a control glass syringe and a cracked glass syringe, respectively, illuminated with green light (530 nm) from a lightbar, in accordance with various embodiments.

FIGS. 22A-22E illustrate an exemplary camera-based syringe crack detection system setup and images acquired using the same in accordance with various embodiments. FIG. 22A illustrates a manual COGNEX camera green light setup; FIG. 22B illustrates an axially illuminated cracked glass syringe; FIG. 22C illustrates an axially illuminated control glass syringe; FIG. 22D illustrates a backlit cracked glass syringe; and FIG. 22E illustrates a backlit control glass syringe.

FIGS. 23A-23D depict images obtained using the system of FIG. 22A. FIG. 23A illustrates an axially illuminated cracked glass syringe; FIG. 23B illustrates an axially illuminated control glass syringe; FIG. 23C illustrates a backlit cracked glass syringe; and FIG. 23D illustrates a backlit control glass syringe.

FIGS. 24A and 24B illustrate a cracked glass vial under ambient light (FIG. 24A) and under green LED light (FIG. 24B) in accordance with some embodiments.

FIG. 25 illustrates a light box, in accordance with some embodiments.

FIG. 26 illustrates an exemplary operating environment, in accordance with some embodiments.

It is noted that the drawings of the disclosure are not necessarily to scale.

### DETAILED DESCRIPTION

Embodiments of the present disclosure relate to methods and systems for inspection of drug packages such as, e.g., primary packaging or containers. More particularly, the disclosure relates to the use of LED light for detection of cracks and defects in such drug packages.

As used herein, the terms “comprises,” “comprising,” “includes,” “including,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. The term “exemplary” is used in the sense of “example,” rather than “ideal.” In addition, the terms “first,” “second,” and the like, herein do not denote any order, quantity, or importance, but rather are used to distinguish an element or a structure from another. Moreover, the terms “a” and “an” herein do not denote a limitation of quantity, but rather denote the presence of one or more of the referenced items.

The term “distal end” or any variation thereof, refers to the portion of a device farthest from an operator of the device during an injection operation. For example, the distal end of a syringe would be the needle end of the syringe, and the distal end of a needle would be the sharp tip. Conversely, the term “proximal end,” or any variation thereof, refers to the portion of the device closest to the operator of the device during an injection operation. For example, the proximal end of a syringe would be the plunger end of the syringe, and the proximal end of a needle would be the end coupled to a needle hub. Further, as used herein, the terms “about,” “substantially,” and “approximately” generally mean ±10% of the indicated value.

As indicated above, and with reference to the figures, methods and systems are disclosed herein for inspecting drug packages by illuminating the drug packages with LED light. Such illumination increases the detectability of defects, e.g., cracks, compared to visual inspection under ambient light conditions.

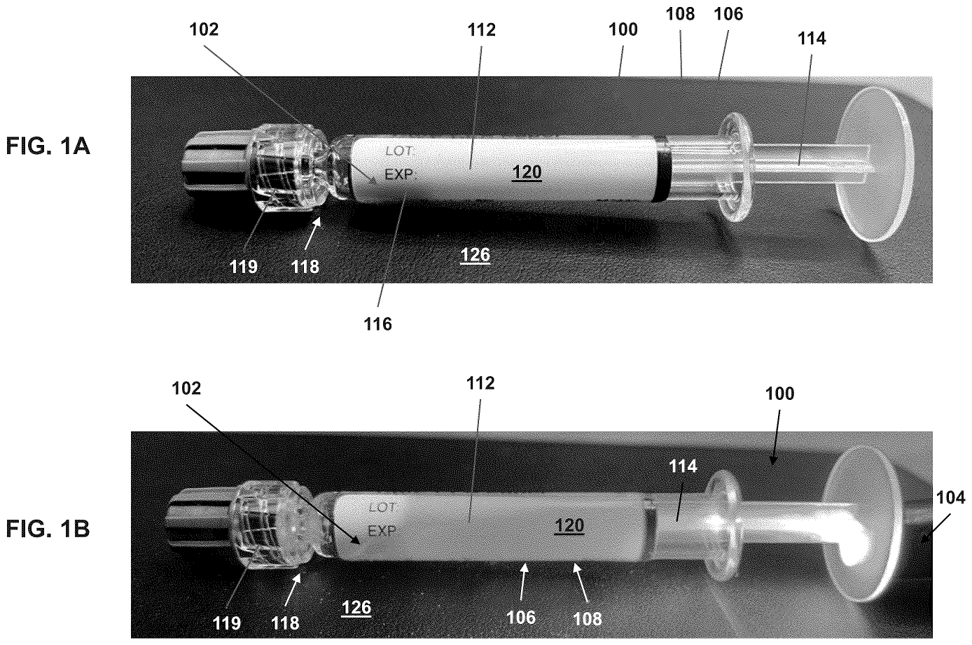

Referring first to FIGS. 1-4, in an aspect of the disclosure, a method is provided for inspecting a drug package 100 by illuminating the drug package 100 using a light-emitting diode (LED) light source 104 (FIGS. 1B, 2B, 3B, and 4B), and visually inspecting the drug package 100 under LED 104 illumination to determine the presence or absence of one or more crack(s) or defect(s) 102 therein. Under illumination from the LED light source 104, crack(s) or defect(s) 102 that are present in the drug package 100 are more visible, i.e., illumination from the LED light source 104 increases the visibility of such crack(s) or defect(s) 102, compared to the visibility of the crack(s) or defect(s) 102 under ambient light (FIGS. 1A, 2A, 3A, 4A).

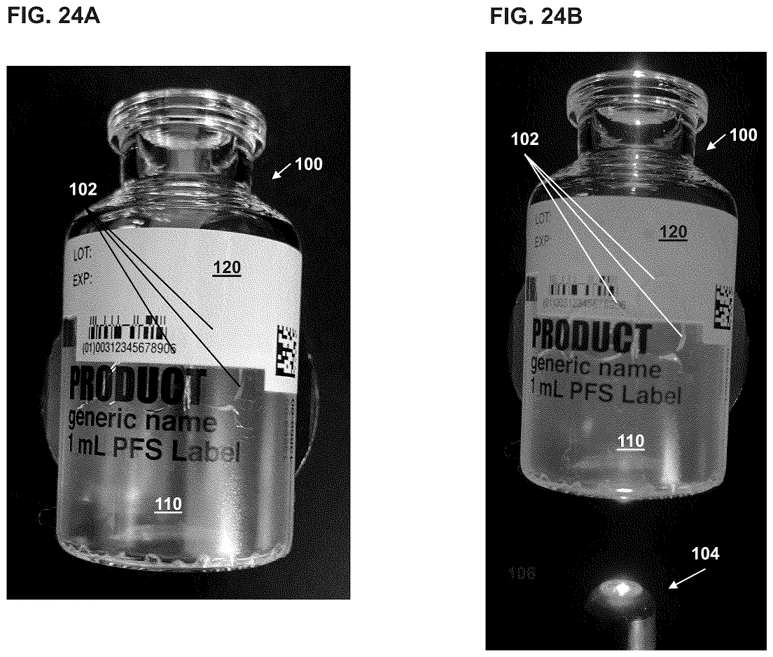

The methods described herein may be used to detect crack(s) or defect(s) 102 in various types of drug packages 100. For example, the drug package 100 may be a primary container 106 or primary package for a drug product, such as, e.g., a syringe 108 (e.g., FIGS. 1-4), a vial 110 (FIG. 24), an ampoule, or a cartridge (not pictured). More particularly, the syringe 108 may be a sterile pre-filled syringe, which may be pre-assembled, and may include a drug product contained within the barrel 112 of the syringe 108 (i.e., the syringe 108 may be filled and finished). A plunger, including a plunger rod 114 and a stopper 116, may be disposed at least partially within the barrel 112 of the syringe. In particular, in certain embodiments, the plunger rod 114 and stopper 116 may be coupled to one another to collectively form a plunger which is partially disposed within the barrel 112 of the syringe 108. The plunger may be movable in a distal direction to expel the drug product from the outlet end 118 of the syringe 108. In other embodiments, the stopper 116 may be disposed within the barrel 112, and the plunger rod 114 may be disposed partially within the barrel such that the plunger rod 114 is movable in a distal direction to cause the stopper 116 to translate distally to expel the drug product from the outlet end 118 of the syringe 108. However, in this latter arrangement, movement of the plunger rod 114 in the proximal direction may not result in movement of the stopper 116. The syringe 108 may further include a cap 119 disposed over the outlet end 108. Other primary containers 106 such as, e.g., vials, cartridges, and ampoules may include analogous fill-finish features, including a drug product disposed therein, a sterile closure, and so on, as will be understood by those of skill in the art.

As noted, the primary container 106 may be pre-filled with a drug product, i.e., a medicament, which may be, e.g., a solid, powder, liquid, gel, or other formulation. The medicament may further be formulated for administration via an oral, parenteral, subcutaneous, intramuscular, intravenous, inhalation, intraocular, or otic route of administration. In certain embodiments, the medicament comprises a small molecule active pharmaceutical ingredient, or a biologic active pharmaceutical ingredient, such as, e.g., a peptide or polypeptide, recombinant DNA, or antibody active pharmaceutical ingredient. In non-limiting examples, the active ingredient may be, e.g., a vascular endothelial growth factor (VEGF) derivative active ingredient such as, e.g., aflibercept, which is described in U.S. Pat. Nos. 7,070,959; 7,303,746; 7,303,747; 7,306,799; 7,374,757; 7,374,758; 7,531,173; 7,608,261; 7,972,598; 8,029,791; 8,092,803; 8,343,737; and 8,647,842, and PCT Publication WO 2023/177689, each of which is incorporated by reference in its entirety; Dupixent (dupilumab), Praluent (alirocumab), Kevzara (sarilumab), or any other medicament which may be stored, contained within, or dispensed from a primary container 106 such as a syringe, vial, cartridge, ampoule, autoinjector, etc.

The primary container 106 may be made of glass or polymer materials, e.g., a cyclic olefin copolymer (COC) or a cyclic olefin polymer (COP). For example, in the case of a syringe 108, the barrel 112 of the syringe 108 may be made of glass or polymer, while other components of the syringe 108 such as the stopper 116, plunger rod 114, cap 119, and so forth may be made of other materials as understood in the art. In the case of a vial 110 (FIG. 24), the container may be made of glass or polymer, while the closures (e.g., stopper, cap) may be made of other materials as understood in the art. In the case of a cartridge, the cartridge body may be made of glass or polymer, while the plunger and seal may be made of other materials as understood in the art. In further cases, the ampoule may be made of glass or polymer as disclosed herein.

In any of the foregoing embodiments, the drug package 100 may include a label 120 disposed or affixed to an outer surface thereof. Particularly, the label 120 may be disposed on an outward-facing glass or polymer surface of the drug package 100, as shown in the figures generally. In some cases, the label 120 may be opaque or substantially opaque (e.g., 55-100% opaque, or about 55% opaque, about 60% opaque, about 65% opaque, about 70% opaque, about 75% opaque, about 80% opaque, about 85% opaque, about 90% opaque, about 95% opaque, or greater than 95% opaque), while in other cases, the label 120 may be transparent or translucent (e.g., about 0-54% opaque, or about 0% opaque, about 5% opaque, about 10% opaque, about 15% opaque, about 20% opaque, about 25% opaque, about 30% opaque, about 35% opaque, about 40% opaque, about 45% opaque, or about 50% opaque). In particular examples, the label 120 may be a low-opacity (54%) label, such as manufactured by Winpak Ltd. (Winnipeg, Canada) (“Winpak Less Opacity” label), or a standard opacity (89%) commercial label, such as manufactured by SCHREINER.

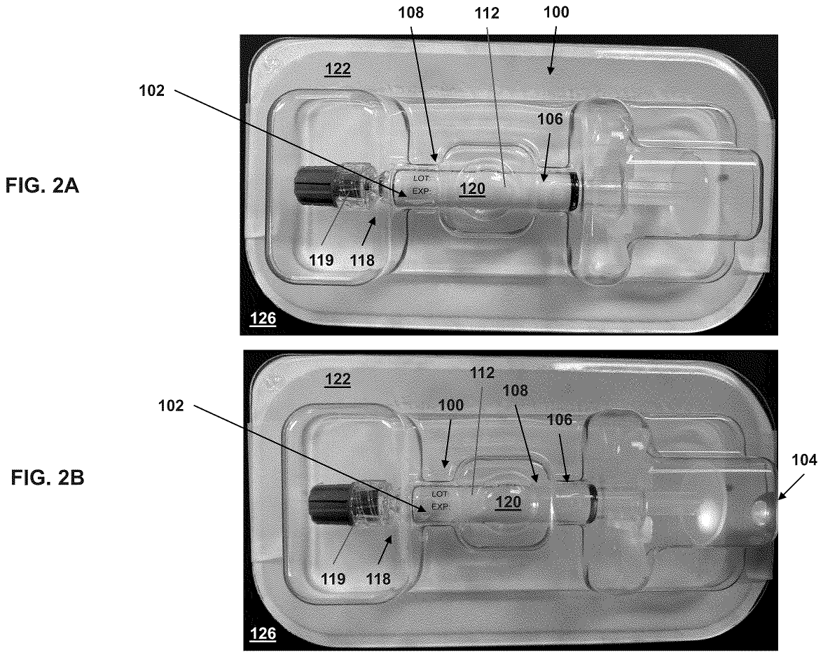

In certain embodiments such as, e.g., those shown in FIGS. 2-4, the primary container 106 may be disposed within a secondary container 122. For example, a primary container 106 such as a syringe, vial, cartridge, or ampoule may be contained within a secondary container 122 such as a blister package. In certain embodiments, the secondary container 122 may be transparent or translucent in whole or in part, enabling visual inspection of the primary container 106 disposed therein, while maintaining the sterility of the contents of the secondary container 122.

In certain embodiments such as shown in, e.g., FIGS. 1-2, the drug package 100 may be disposed directly on a flat surface 126 such as, e.g., a table, counter, lab benchtop, conveyor belt surface, etc., for inspection. Each drug package may be inspected individually.

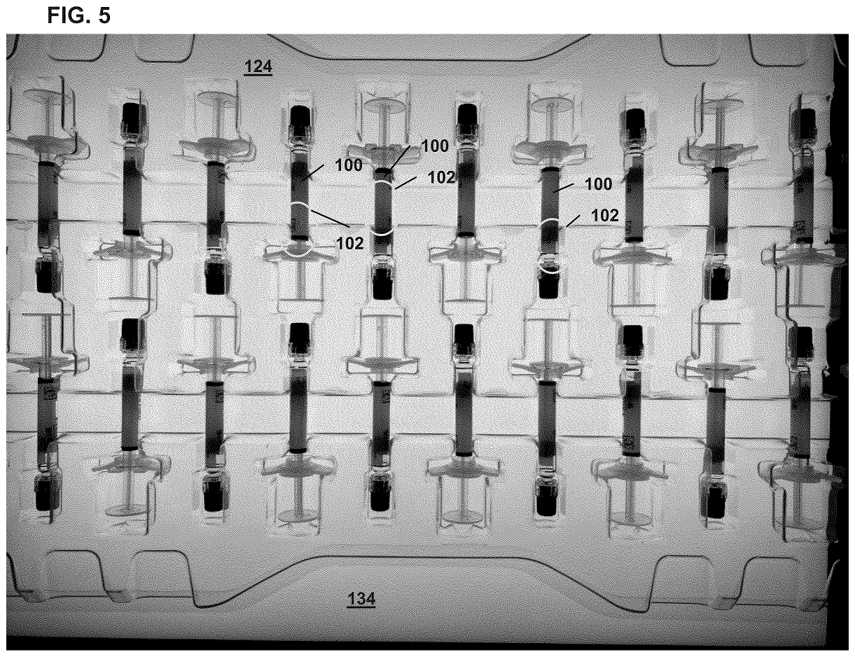

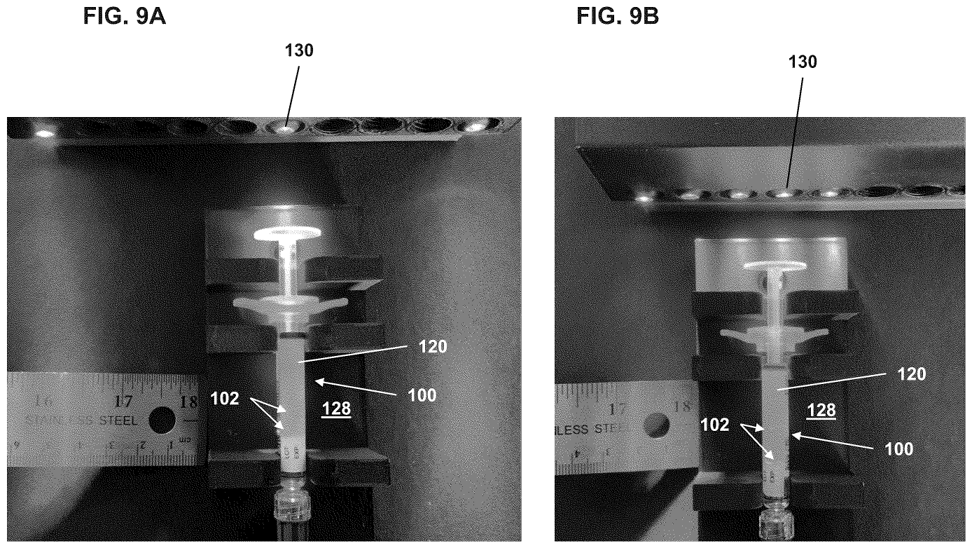

In other embodiments, such as shown in FIGS. 5-8, the drug package 100 may be disposed within a tray 124 adapted to securely retain one or more drug packages 100. The tray 124 may particularly be adapted to securely retain a plurality of drug packages 100 for batch inspection thereof. In certain embodiments, the tray 124 may be made of a translucent or transparent material, e.g., plastic, to enable the drug package(s) 100 to be illuminated and visually inspected without removing the drug package(s) 100 from the tray 124. In further embodiments, such as shown in FIG. 9, the drug package 100 may be disposed in a puck 128 adapted to securely retain the drug package 100. For example, where the drug package 100 is a syringe, a finger flange puck 128 may be used to hold or contain the syringe during inspection thereof.

In still further embodiments, inspection using any of the illumination techniques described herein may be deployed in any means known in the art. For example, inspection via illumination may be deployed in a continuous or semi-continuous manner along an assembly line similar to, e.g., the assembly line described in International Patent Application No. PCT/US2017/043595, filed Jul. 25, 2017 and published as WO 2018/022546 A1, entitled “ASSEMBLY LINE WITH INTEGRATED ELECTRONIC VISUAL INSPECTION,” which is incorporated by reference as though fully set forth herein. In certain examples, batches of drug packages may be conveyed past an LED light source by a conveyor belt or similar apparatus, for inspection in accordance with embodiments of the present disclosure.

As noted above, any of the foregoing drug packages 100, including those disposed in a secondary container 122, may be inspected by illuminating the drug package 100 using a light-emitting diode (LED) light source 104, and visually inspecting the drug package 100 under LED 104 illumination. In various embodiments, the LED light source 104 may emit light of any visible or optically detectable wavelength. For example, the LED light source may emit visible light, infrared (IR) light (e.g., about 700 nm to about 1 mm, or about 850 nm), or ultraviolet (UV) light (e.g., about 10 nm to about 400 nm). In particular, the LED light source may emit visible white light (e.g., about 400 to about 700 nm) or green light (e.g., about 495 nm to about 570 nm, or about 530 nm).

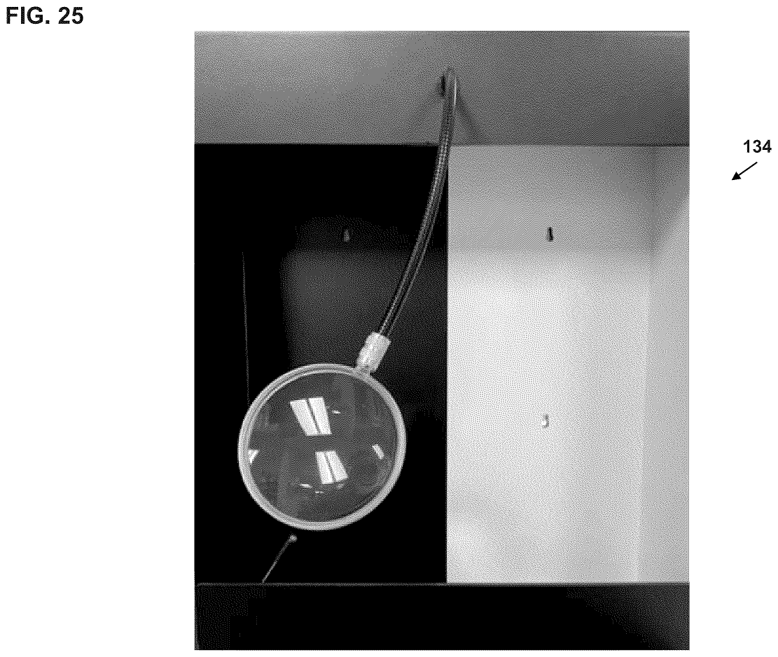

The drug package 100 may further be illuminated in any manner known to those of ordinary skill in the art. In certain embodiments, the drug package 100 may be backlit by the LED light source 104 as shown in, e.g., FIGS. 5, 7, 22D, 22E, 23C, and 23D, by a light source such as, e.g., a light box 134 (FIG. 25). In other embodiments, the drug package 100 may be axially illuminated by the LED light source 104, i.e., light may be directed along a longitudinal axis of the drug package 100, as shown in, e.g., FIGS. 1B, 2B, 3B, 4B, 6, 8, 9A-9B, 10-16, 22B, 22C, 23A, 23B, and 24B. In embodiments in which the drug package 100 is a syringe, the axial illumination may be directed approximately along the plunger rod 114 of the syringe (FIG. 1B).

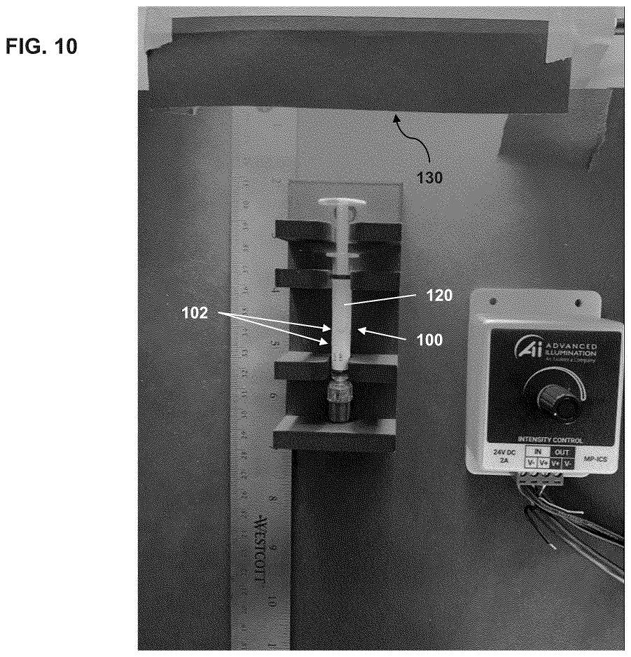

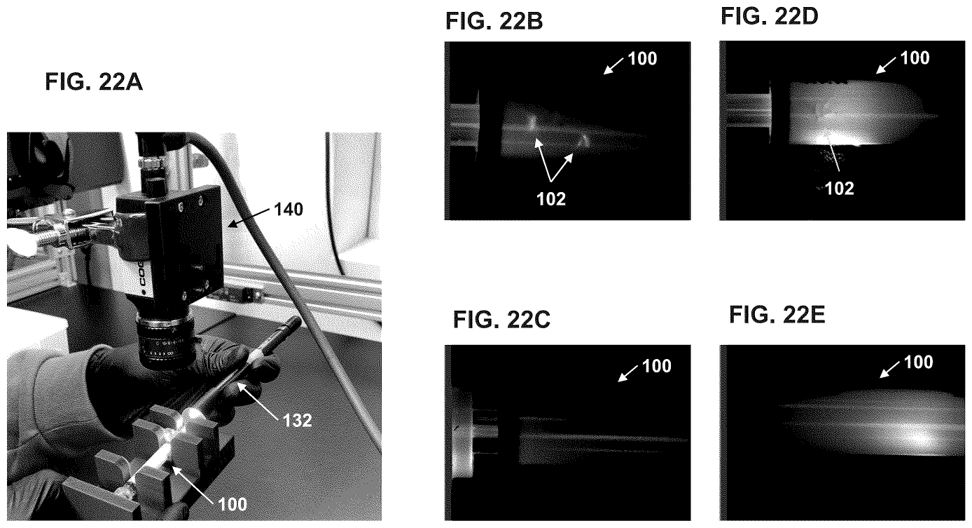

Various LED light sources 104 may be used to axially illuminate the drug package 100 such as, e.g., a light bar 130 (e.g., FIGS. 10-21) or a pen light 132 (e.g., FIGS. 22B-22E, 23A-23D, 24B). Exemplary light bars 130 include those made by Edmund Optics (Barrington, NJ, USA), while exemplary pen lights include those made by Streamlight (Eagleville, PA, USA), e.g., the STYLUS penlight.

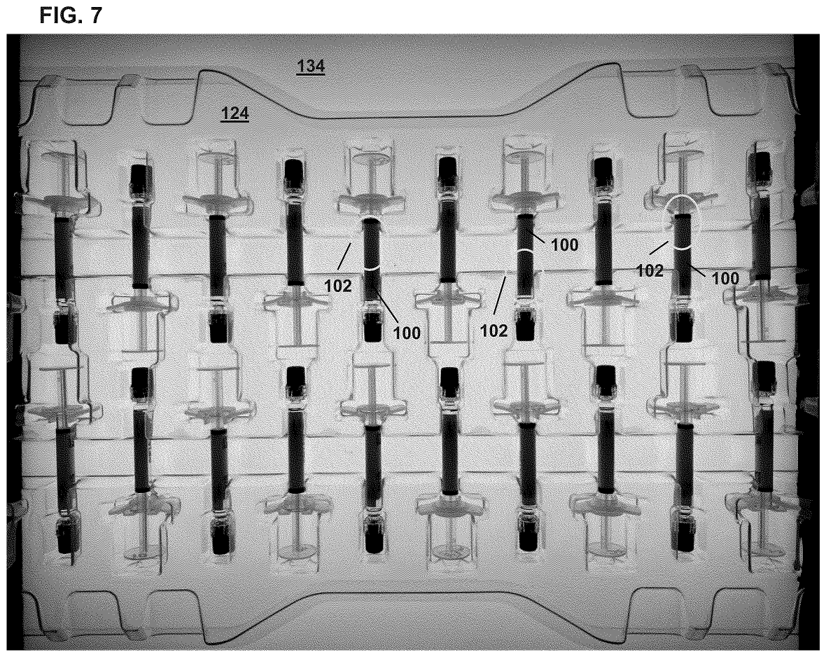

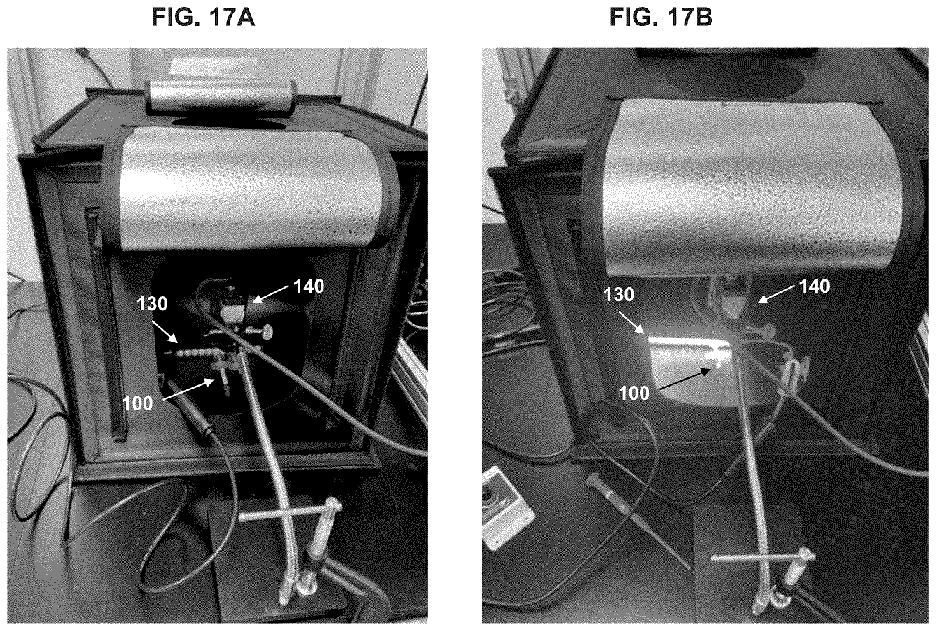

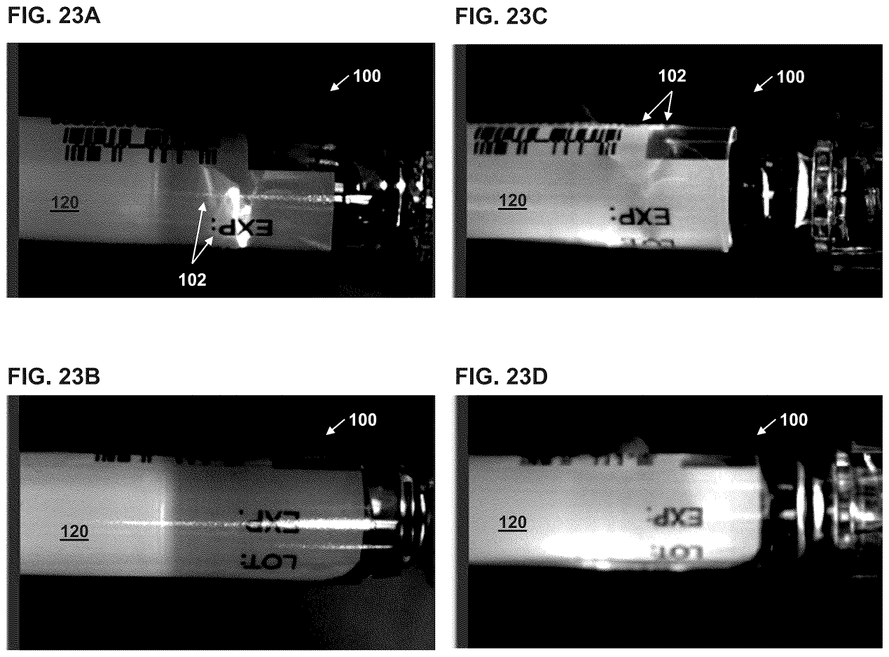

The direction of the illumination, e.g., backlighting or axial illumination, may be selected independently of the color or wavelength of light, such that light of any of the previously described wavelengths may be combined with either of the foregoing lighting directions. The drug packages 100 may therefore be backlit with, e.g., white light, green light, or infrared light, or may be axially illuminated with, e.g., white light, green light, or infrared light emanating from any of a light bar, pen light, or other LED light source. In particular embodiments, drug packages 100 may be illuminated with white backlight (as shown in, e.g., FIGS. 5 and 7), white axial light, green backlight (as shown in, e.g., FIGS. 22D, 22E, 23C, 23D), green axial light (as shown in, e.g., FIGS. 1B, 2B, 3B, 4B, 6, 8, 9A, 9B, 10-16, 17B, 24B), infrared backlight, infrared axial light (as shown in, e.g., FIG. 17A), and so on.

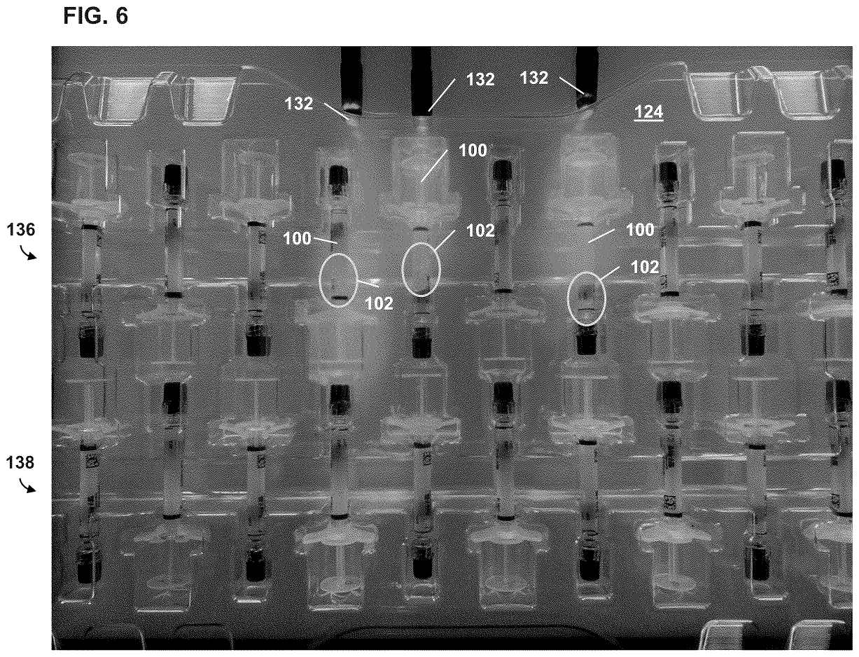

The drug package(s) 100 to be inspected according to embodiments of the present disclosure may be positioned at varied distances from the LED light source 104. For example, in certain embodiments in which the drug package 100 is axially illuminated by a light bar 130, the drug package 100 may be positioned at a distance from the light bar 130 of about 0 inches (about 0 cm) to about 36 inches (about 91.44 cm) or more, e.g., greater than about 36 inches (about 91.44 cm), from about 0 inches (about 0 cm) to about 36 inches (91.44 cm), from about 0 inches (0 cm) to about 24 inches (about 60.96 cm), from about 0 inches (0 cm) to about 8 inches (about 20.32 cm), or about 2 inches (about 5.08 cm) to about 8 inches (about 20.32 cm). Additionally, drug packages 100 may be disposed in a plurality of rows such as, e.g., a first row 136, a second row 138 of a tray 124 (FIG. 6), and optionally in additional rows (not pictured). Drug packages 100 disposed in the first row 136 may be located nearer to the LED light source than those in the second row 138; nonetheless, drug packages 100 in multiple rows may all be within the range of distances from the LED light source described herein, and may be inspected simultaneously. The inspection methods described herein may therefore be amenable to a variety of applications and environments, e.g., fill lines, assembly lines, labeling lines, and so on.

Additionally, the light bar may be deployed using varying light intensities, e.g., low, medium, or high power output. In certain embodiments, the intensity of the light bar may be selected independently of the distance between the drug package 100 and the light bar 130, while maintaining the ability to enhance visual inspection compared to ambient light conditions, and facilitate visual identification of defects, e.g., cracks 102 in drug packages 100. In other embodiments, the intensity of light emitted by the light bar 130 may be selected in relation to the distance between the light bar 130 and the drug package(s) 100 to be inspected. While light of any intensity may be used to inspect drug packages 100 placed relatively near the light bar 130, in general, the use of higher intensity light may enable inspection of drug package(s) 100 positioned at a relatively greater distance from the light bar 130 in accordance with various embodiments of the disclosure.

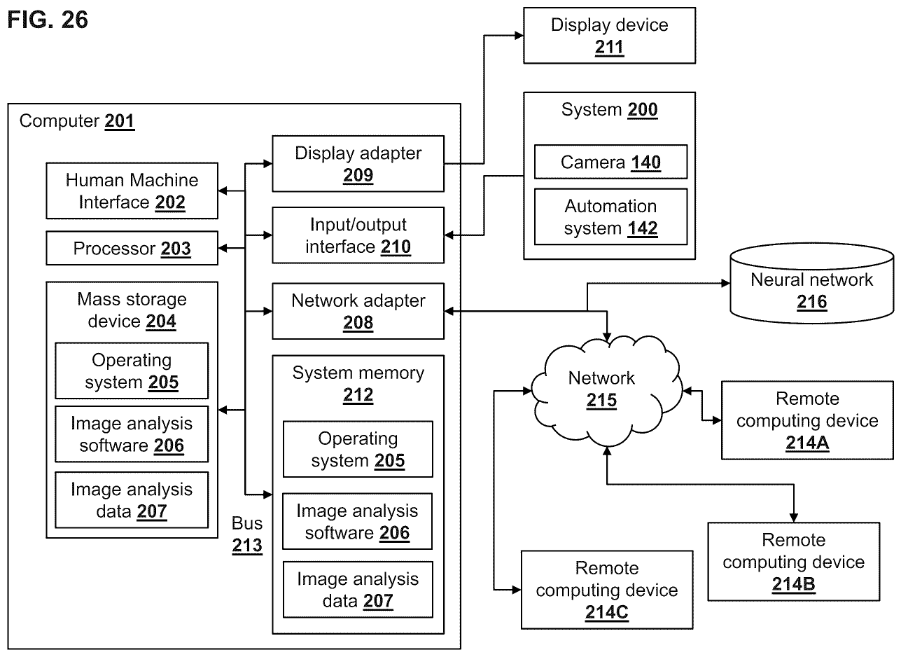

In certain embodiments, drug packages 100 illuminated as described above may be visually inspected by a human operator. In other embodiments, referring to FIGS. 17A, 17B, 22A, and 26, visual inspection of the illuminated drug package(s) 100 may be implemented by a system 200 including a camera 140 (illustrated in FIGS. 17A, 17B, 22A, and 26) in communication with a computing device, e.g., computer 201 (FIG. 26). According to such embodiments, the inspection method includes using the camera 140 to acquire an image of the drug package 100 under illumination from the LED light source 104, e.g., light bar 130 (FIGS. 17A-B) or pen light 132 (FIG. 22A).

The image acquired by the camera 140 is then communicated to the computer 201 as described further herein. FIGS. 22B-22E and 23A-23D show exemplary images acquired by the camera 140. FIGS. 22B, 22D, 23A, and 23C provide exemplary illustrations of the appearance of cracks 102 in the respective drug package 100 (e.g. syringe) under LED illumination as shown in an image captured with camera 140, while FIGS. 22C, 22E, 23B, and 23D provide exemplary illustrations of the appearance of control (crack-free) drug packages 100 under LED illumination, also in images captured with the camera 140.

The camera 140 may be adapted to obtain monochrome or color images. Exemplary models of camera 140 may include the COGNEX Insight 8200M or Insight 8400 cameras, although others will be identifiable by one skilled in the art. In certain embodiments, various aspects of the image acquisition by camera 140 may be optimized by software executed on computer 201 such as, e.g. PatMax geometric pattern-based object location software from Cognex Corporation (Natick, Massachusetts, USA). Such parameters may include, e.g., magnification of the image, selection of a region of focus, noise reduction, and optimization of other image parameters, e.g., contrast, dimensions, exposure, etc.

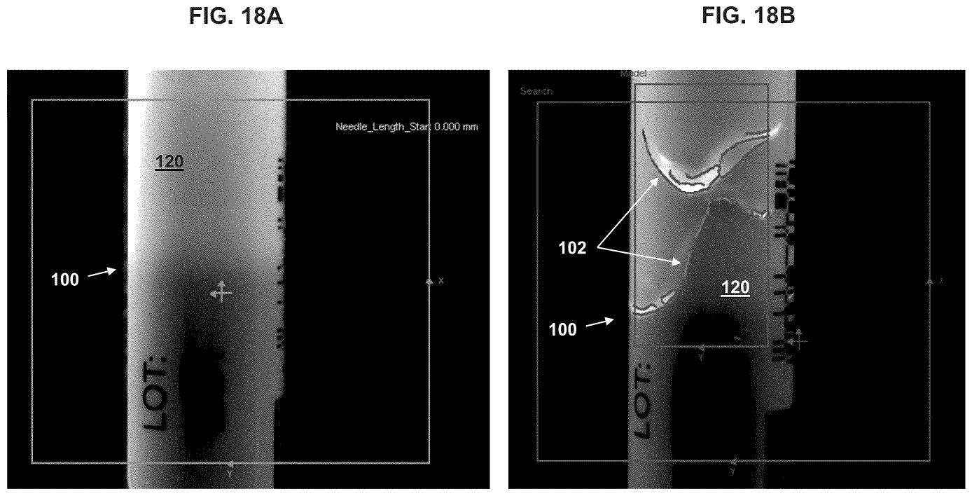

With reference to FIGS. 18-21, the image of drug package 100 captured by the camera 140 may then be inspected by processing the image on the computer 201 to determine the presence or absence of cracks or defects 102 in the drug package 100 shown in the image. Where a crack or defect 102 is present (FIGS. 18B, 19B, 20B, 21B), the defect 102 may be identified and certain downstream processes may be initiated including, e.g., identifying the edges, contours, or contrast of the crack or defect 102 on the image, and generating and displaying a notification to notify the user of the defect in the inspected drug package 100. The notification may be output in any form such as, e.g., a visual representation including, but not limited to, textual, graphical, animation, audio, tactile, and the like, an audio notification, or other form as will be understood by those of skill in the art. The notification may be output to any output device such as, e.g., a display device 211 (FIG. 26) such as, e.g., a monitor, an LCD (Liquid Crystal Display), light emitting diode (LED) display, television, smart lens, smart glass, and/or a projector, for example in the form of a pop-up message on a monitor, a visual signal on an LED display, or other type of notification. The notification may additionally or alternatively be output to a second output peripheral device such as, e.g., a speaker, a printer, or other peripheral device connected to the computer 201, e.g., via an input/output interface 210. In further embodiments, the notification may include an action, e.g., an automated action, performed by an automation system 142 (FIG. 26) in response to the identification of a defect 102 in a drug package 100. In one example, a drug package 100 that is determined to include a defect 102 therein (e.g., FIGS. 18B, 19B, 20B, 21B, 22B, 22D, 23A, 23C) may be separated from a batch or rejected by automation system 142 based on the defect 102 therein. This may include, e.g., sending, directing, or diverting the defective drug package 100 to a rejection bin or other location distinct from that of defect-free drug packages 100 after inspection. The defective drug package 100 may alternatively be sent, directed, or diverted to undergo further inspection, e.g., manual inspection or inspection under increased magnification. In further embodiments, the notification may include marking a drug package 100 determined to include a defect 102, e.g., by the application of a stamp or other marking associated with the defect-containing status, by the automation system 142.

The present methods and systems can be operational with numerous other general purpose or special purpose computing system environments or configurations. Examples of well-known computing systems, environments, and/or configurations that can be suitable for use with the systems and methods comprise, but are not limited to personal computers, server computers, laptop devices, and multiprocessor systems. Additional examples comprise set top boxes, programmable consumer electronics, network PCs, programmable logic controllers (PLCs), minicomputers, mainframe computers, distributed computing environments that comprise any of the above systems or devices, and the like.

The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices.

Further, one skilled in the art will appreciate that the systems and methods disclosed herein can be implemented via a general-purpose computing device in the form of a computer 201. The computer 201 can comprise one or more components, such as one or more processors 203, a system memory 212, and a bus 213 that couples various components of the computer 201 including the one or more processors 203 to the system memory 212. In the case of multiple processors 203, the system can utilize parallel computing.

The bus 213 can comprise one or more of several possible types of bus structures, such as a memory bus, memory controller, a peripheral bus, an accelerated graphics port, and a processor or local bus using any of a variety of bus architectures. The bus 213, and all buses specified in this description can also be implemented over a wired or wireless network connection.

The computer 201 typically comprises a variety of computer readable media. Exemplary readable media can be any available media that is accessible by the computer 201 and comprises, for example and not meant to be limiting, both volatile and non-volatile media, removable and non-removable media. The system memory 212 can comprise computer readable media in the form of volatile memory, such as random access memory (RAM), and/or non-volatile memory, such as read only memory (ROM). The system memory 212 typically can comprise data such as image analysis data 207 and/or program modules such as operating system 205 and image analysis software 206 that are accessible to and/or are operated on by the one or more processors 203.

In another aspect, the computer 201 can also comprise other removable/non-removable, volatile/non-volatile computer storage media. The mass storage device 204 can provide non-volatile storage of computer code, computer readable instructions, data structures, program modules, and other data for the computer 201. For example, a mass storage device 204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 204, including by way of example, an operating system 205 and image analysis software 206. One or more of the operating system 205 and image analysis software 206 (or some combination thereof) can comprise elements of the programming and the image analysis software 206. Image analysis data 207 can also be stored on the mass storage device 204. Image analysis data 207 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 215.

In certain embodiments, the image analysis software 206 may perform processing of the images acquired by the camera 140, including, e.g., edge detection software capable of detecting cracks in drug packages, including those located under a label. In particular embodiments, such software components may include the COGNEX In-Sight Explorer application, and PatMax software tool. In further embodiments, artificial intelligence (AI) and machine learning may be used to assist in detection of defects, as discussed herein below.

In another aspect, the user can enter commands and information into the computer 201 via an input device (not shown). Examples of such input devices comprise, but are not limited to, a keyboard, pointing device (e.g., a computer mouse, remote control), a microphone, a joystick, a scanner, touch-enabled devices such as a touchscreen, tactile input devices such as gloves and other body coverings, motion sensors, and the like. These and other input devices can be connected to the one or more processors 203 via a human machine interface 202 that is coupled to the bus 213, but can be connected by other interface and bus structures, such as, but not limited to, a parallel port, game port, an IEEE 1394 Port (also known as a Firewire port), a serial port, network adapter 208, and/or a universal serial bus (USB).

In yet another aspect, a display device 211 can also be connected to the bus 213 via an interface, such as a display adapter 209. It is contemplated that the computer 201 can have more than one display adapter 209 and the computer 201 can have more than one display device 211. For example, a display device 211 can be a monitor, an LCD (Liquid Crystal Display), light emitting diode (LED) display, television, smart lens, smart glass, and/or a projector. In addition to the display device 211, other output peripheral devices can comprise components such as speakers (not shown) and a printer (not shown) which can be connected to the computer 201 via Input/Output Interface 210. Any step and/or result of the methods can be output in any form to an output device. Such output can be any form of visual representation, including, but not limited to, textual, graphical, animation, audio, tactile, and the like. The display 211 and computer 201 can be part of one device, or separate devices.

In an aspect, the computer 201 can be coupled to the system 200 via the Input/Output Interface 210. The computer 201 can be configured to monitor and store data. The computer 201 can be configured to store images acquired by cameras connected to the system 200, store data related to pass/fail statistics generated during system-generated inspections, etc. The computer 201 can also be used as a programming interface to one or more smart devices (e.g., smart cameras) and/or embedded logic controllers that require customized firmware to operate. The computer 201 can be used to generate, troubleshoot, upload, and store iterations of this software or firmware.

The computer 201 can operate in a networked environment using logical connections to one or more remote computing devices 214A, 214B, 214C. By way of example, each remote computing device 214A, 214B, 214C can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 201 and a remote computing device 214A, 214B, 214C can be made via a network 215, such as a local area network (LAN) and/or a general wide area network (WAN). Such network connections can be through a network adapter 208. A network adapter 208 can be implemented in both wired and wireless environments. Such networking environments are conventional and commonplace in dwellings, offices, enterprise-wide computer networks, intranets, and the Internet. In an aspect, the network adapter 208 can be configured to provide power to one or more connected devices (e.g., a camera). For example, the network adapter 208 can adhere to the Power-over-Ethernet (PoE) standard or the like.

For purposes of illustration, application programs and other executable program components such as the operating system 205 are illustrated herein as discrete blocks, although it is recognized that such programs and components can reside at various times in different storage components of the computer 201, and are executed by the one or more processors 203 of the computer 201. An implementation of image analysis software 206 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems described herein can employ artificial intelligence (AI) techniques such as machine learning and iterative learning. Examples of such techniques include, but are not limited to, expert systems, case-based reasoning, Bayesian networks, behavior-based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning). Accordingly, the computer 201 may be in communication with a neural network 216 to facilitate the use of a machine learning algorithm to process the image acquired by camera 140.

Inspection as described herein is useful for the detection of cracks or defects in drug packages, including those that, under ambient light conditions, are partially or wholly obscured or covered by a label 120 on the drug package. As illustrated by the figures and described relative to the examples (below), the inspection methods of the present disclosure are effective to inspect drug packages bearing opaque or mostly opaque labels, as well as those bearing comparatively low-opacity labels.

### EXAMPLES

### Example 1: Green LED Axial Illumination vs. Ambient Light

FIGS. 1-4 provide an overview illustration of the visibility of cracks in syringes in ambient light conditions (FIGS. 1A, 2A, 3A, 4A), as compared to LED (e.g., green LED) illumination (FIGS. 1B, 2B, 3B, 4B).

FIGS. 1A and 1B illustrate a cracked glass syringe in ambient light conditions (FIG. 1A) and axially illuminated by green LED light (FIG. 1B). The crack, located beneath the label, is significantly more visible in FIG. 1B than FIG. 1A.

FIGS. 2A and 2B illustrate a cracked glass syringe in a blister package in ambient light conditions (FIG. 2A) and axially illuminated by green LED light (FIG. 2B). The crack, located beneath the label, is significantly more visible in FIG. 2B than FIG. 2A.

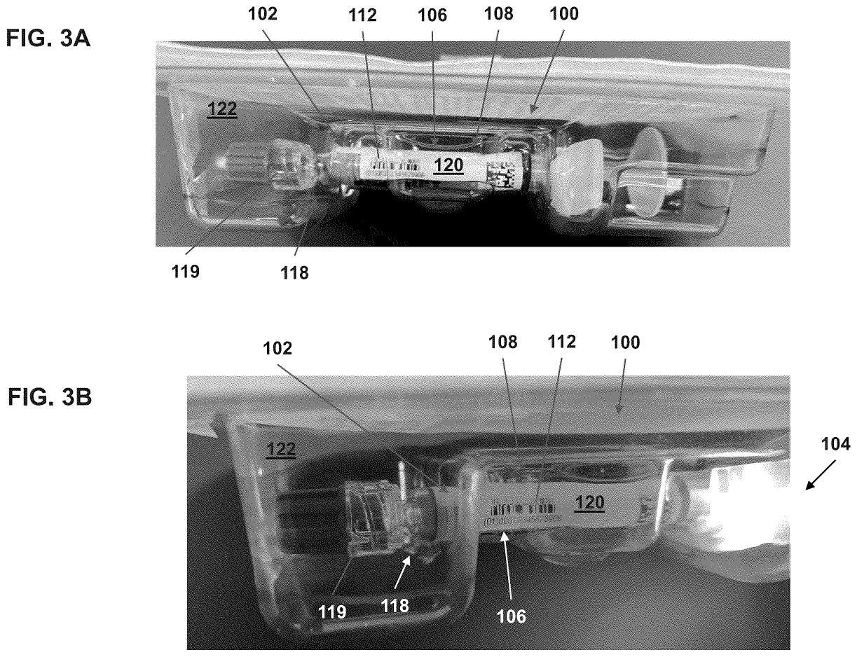

FIGS. 3A and 3B illustrate a cracked glass syringe in a blister package in ambient light conditions (FIG. 3A) and axially illuminated by green LED light (FIG. 3B). The crack is significantly more visible in FIG. 3B than FIG. 3A.

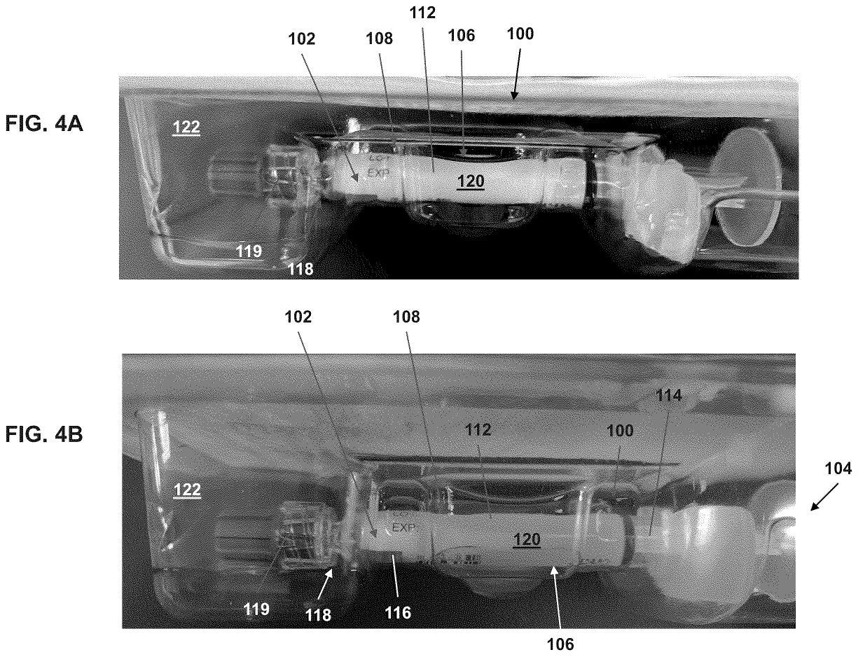

FIGS. 4A and 4B illustrate a cracked glass syringe in a blister package in ambient light conditions (FIG. 4A) and axially illuminated by green LED light (FIG. 4B). The crack is significantly more visible in FIG. 4B than FIG. 4A.

### Example 2: Lightbox/Finger Flange Puck Evaluation

FIGS. 5-9 illustrate syringe crack detection under varying illumination conditions.

FIG. 5 illustrates a plurality of glass syringes, each bearing a low-opacity (54%) label from WINPAK (“Winpak Less Opacity” label). The glass syringes are disposed in a clear tray, and are backlit with white light emitted by a lightbox. In FIG. 5, three syringes with cracks are identified, as indicated by yellow circles.

FIG. 6 illustrates a plurality of glass syringes, each bearing a low-opacity (54%) label from WINPAK (“Winpak Less Opacity” label). The glass syringes are disposed in a clear tray, and illuminated with green light from an LED light source, e.g., a pen light. Unlike FIG. 5, in which the syringes are backlit, the syringes in FIG. 6 are axially (or obliquely) lit, such that the light from the LED light source is directed along the plunger rod of the syringe. In FIG. 6, three syringes with cracks are identified, as indicated by yellow circles.

FIG. 7 illustrates a plurality of glass syringes disposed in a clear tray, and backlit with white light emitted by a lightbox, similar to FIG. 5. Differing from FIG. 5, each syringe in FIG. 7 bears a standard opacity (89%) commercial label made by Schreiner Group LP (Blauvelt, NY, USA). Three syringes with cracks are identified in FIG. 7, as indicated by yellow circles.

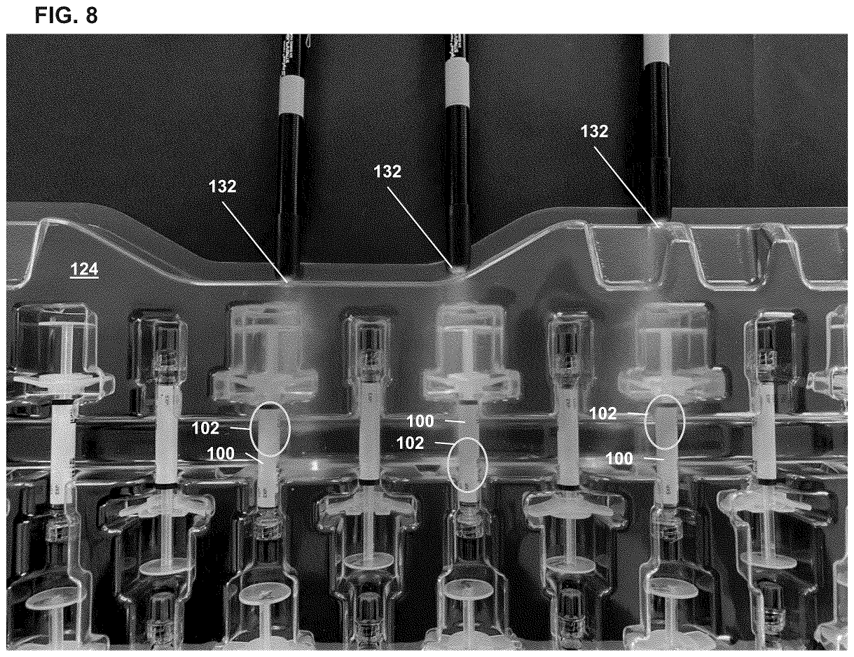

FIG. 8 illustrates a plurality of glass syringes disposed in a clear tray, and axially (or obliquely) illuminated with green light from an LED light source, e.g., a pen light, similar to FIG. 6. The light from the LED light source is directed along the plunger rod of the syringe, e.g., from proximal end to distal end. Each syringe in FIG. 8 bears a standard opacity (89%) commercial label made by SCHREINER. In FIG. 8, three syringes with cracks are identified, as indicated by yellow circles.

FIGS. 9A and 9B each depict a glass syringe disposed in a finger flange puck. In FIG. 9A, the syringe, bearing a standard opacity (89%) commercial label made by SCHREINER, is illuminated with three separated green LEDs. In FIG. 9B, the syringe, bearing a low-opacity (54%) label from Winpak Ltd. (Winnipeg, Canada) (“Winpak Less Opacity” label) is illuminated with green LEDs mimicking a lightbar.

Compared to ambient light, FIGS. 5-9 collectively show that backlight illumination with white light and axial illumination with green light both provide improved visibility of cracks in syringes compared to ambient light, in both syringes having low-opacity (54%) and standard opacity (89%) labels disposed thereon. Axial illumination provides improved visibility of cracks compared to backlight illumination regardless of label opacity. Additionally, green LED light, regardless of source (e.g., spaced LEDs, simulated lightbar, or manual application with a pen light) all provide similar visualization of cracks.

### Example 3: Lightbar/Finger Flange Puck and Tray Evaluation

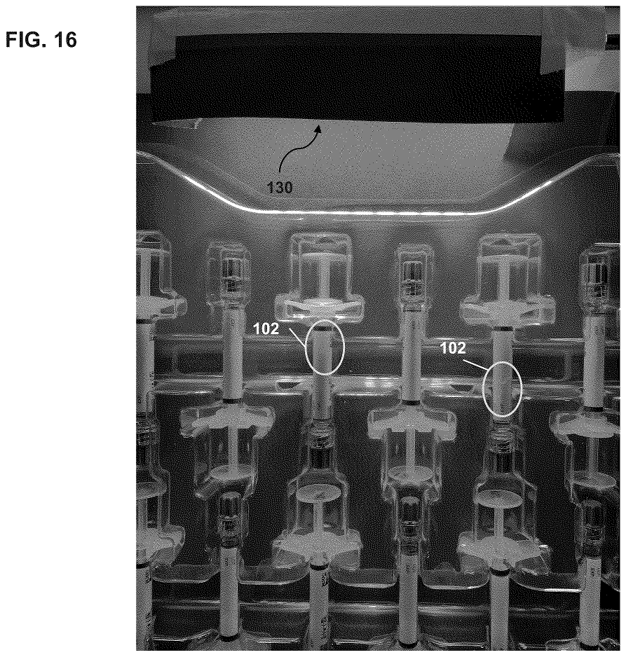

FIGS. 10-16 depict crack detection using a lightbar (Edmund Optics) in individual syringes having a standard opacity (89%) commercial label by SCHREINER and disposed in finger flange pucks (FIGS. 10-15) and disposed in clear trays (batches) (FIG. 16), at varying light intensities and varying distances between the LED light source and the syringe(s).

FIG. 10 illustrates a glass syringe bearing a standard opacity (89%) label (SCHREINER) and disposed in a finger flange puck. The syringe is axially illuminated with a green light lightbar at the lowest available power output, at a distance of about 2 inches from the proximal end of the finger flange puck.

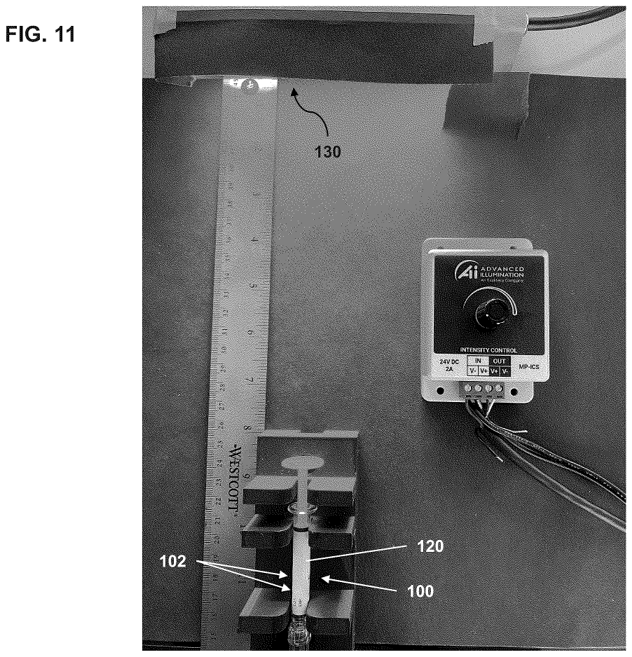

FIG. 11 illustrates a glass syringe bearing a standard opacity (89%) label (SCHREINER) and disposed in a finger flange puck. The syringe is axially illuminated with a green light lightbar at the lowest power output at a distance of about 8 inches from the proximal end of the finger flange puck.

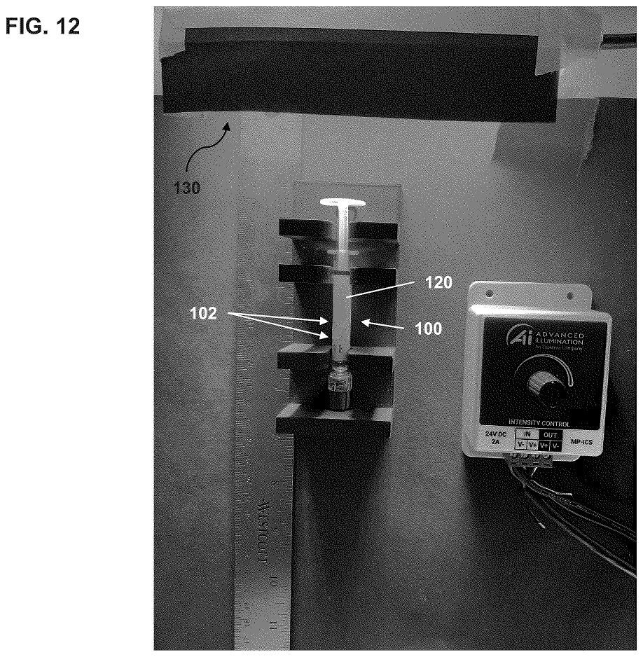

FIG. 12 illustrates a glass syringe bearing a standard opacity (89%) label (SCHREINER) and disposed in a finger flange puck. The syringe is axially illuminated with a green light lightbar at medium power output at a distance of about 2 inches from the proximal end of the finger flange puck.

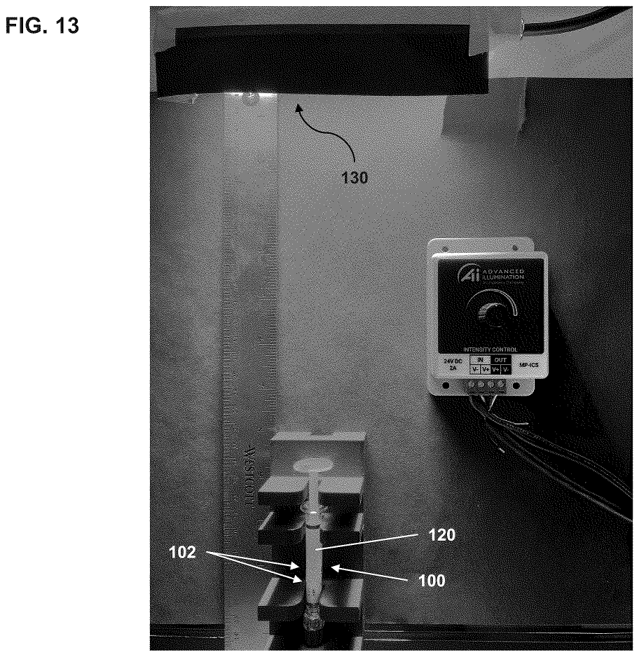

FIG. 13 illustrates a glass syringe bearing a standard opacity (89%) label (SCHREINER) and disposed in a finger flange puck. The syringe is axially illuminated with a green light lightbar at medium power output at a distance of about 8 inches from the proximal end of the finger flange puck.

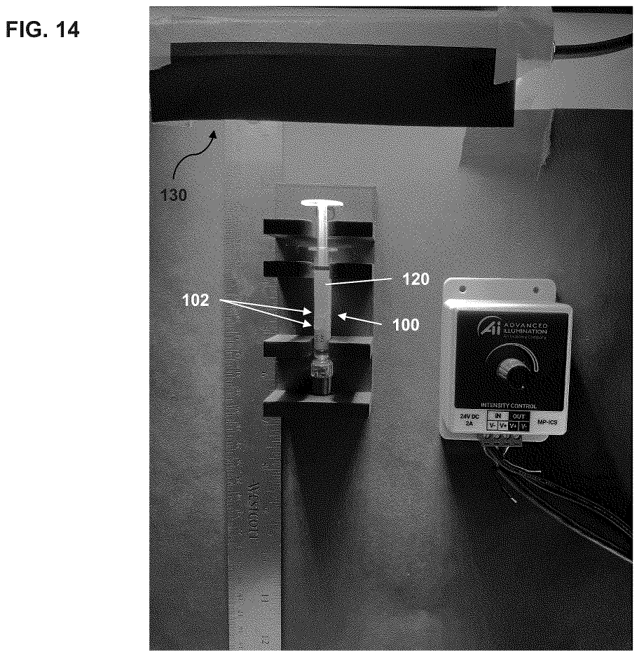

FIG. 14 illustrates a glass syringe bearing a standard opacity (89%) label (SCHREINER) and disposed in a finger flange puck. The syringe is axially illuminated with a green light lightbar at high power output at a distance of about 2 inches from the proximal end of the finger flange puck.

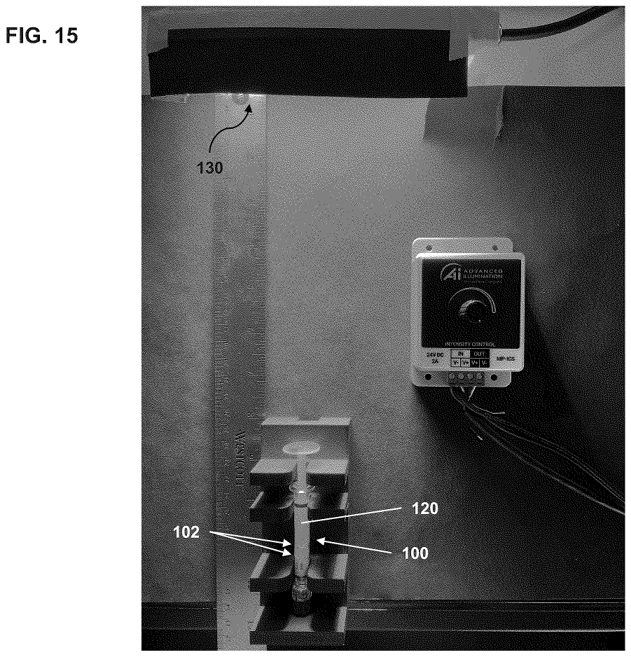

FIG. 15 illustrates a glass syringe bearing a standard opacity (89%) label (SCHREINER) and disposed in a finger flange puck. The syringe is axially illuminated with a green light lightbar at high power output at a distance of about 8 inches from the proximal end of the finger flange puck.

FIG. 16 illustrates a plurality of glass syringes bearing standard opacity (89%) labels (SCHREINER) and disposed in a clear tray. The syringes in the tray are axially illuminated with a green light lightbar. Two syringes with cracks identified, as circled in FIG. 16.

FIGS. 10-16 collectively show that axially directed light from green LED light sources are effective to highlight defects, e.g., cracks in syringes. The green LED illumination may be applied at varied distances from the syringes (e.g., 2-8 inches), and at varied intensities (e.g., high, medium, low), while maintaining the ability to enhance visual inspection and visual identification of defects, e.g., cracks in syringes.

### Example 4: Green LED and IR Lightbar Assessment

FIGS. 17-21 depict crack detection in individual syringes using a green LED lightbar and an infrared (IR) lightbar (Edmund Optics).

FIGS. 17A and 17B illustrate lab benchtop setups for performing syringe crack detection utilizing an Edmund Optics infrared (IR) lightbar (FIG. 17A) and an Edmund Optics green LED lightbar (FIG. 17B).

FIGS. 18A and 18B illustrate a control glass syringe (no crack) (FIG. 18A) and a cracked glass syringe (FIG. 18B), each bearing a standard opacity (89%) label (SCHREINER) and illuminated with IR light (850 nm) from a lightbar in a setup as shown in FIG. 17A.

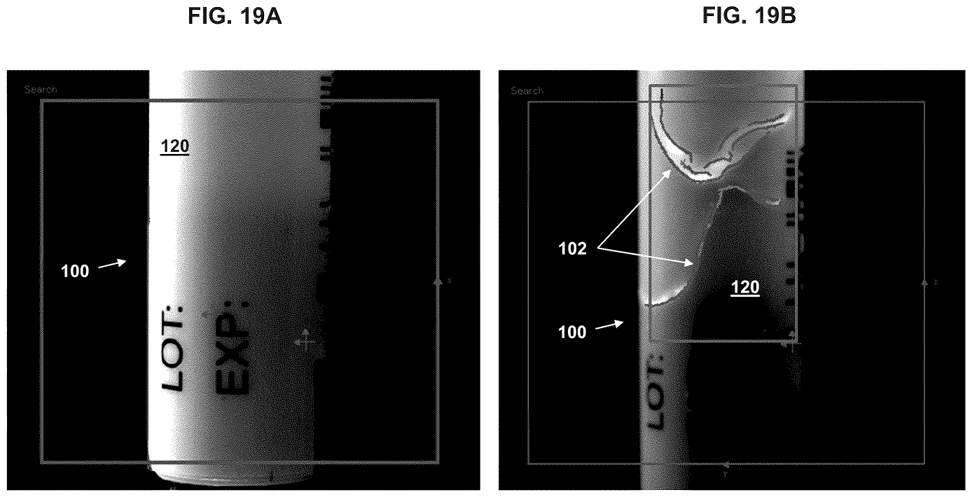

FIGS. 19A and 19B illustrate a control glass syringe (no crack) (FIG. 19A) and a cracked glass syringe (FIG. 19B), each bearing a standard opacity (89%) label (SCHREINER) and illuminated with green light (530 nm) from a lightbar, in a setup as shown in FIG. 17B.

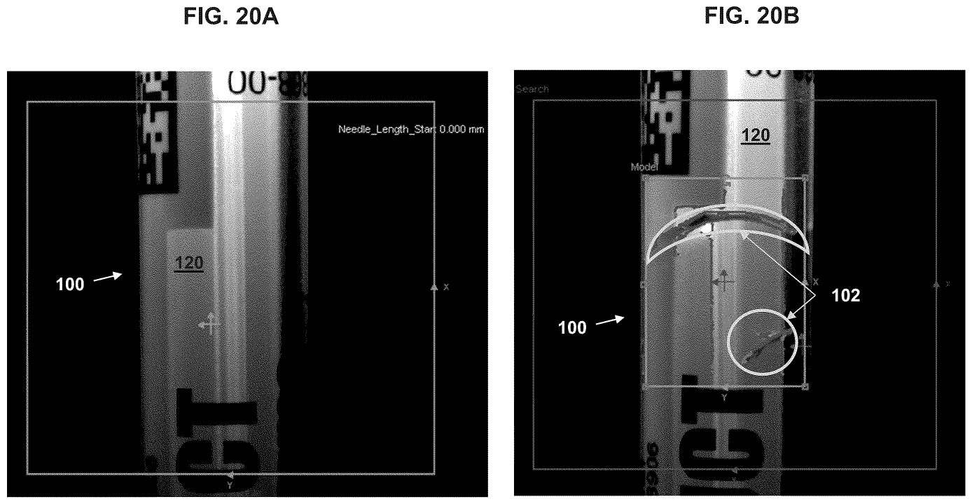

FIGS. 20A and 20B illustrate a control glass syringe (no crack) (FIG. 20A) and a cracked glass syringe (FIG. 20B), each bearing a standard opacity (89%) label (SCHREINER) and illuminated with IR light (850 nm) from a lightbar, as shown in FIG. 17A.

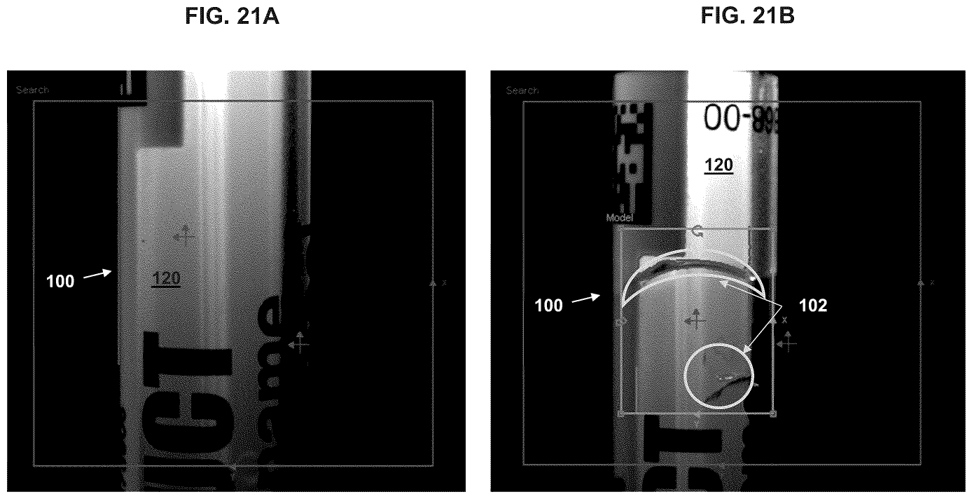

FIGS. 21A and 21B illustrate a control glass syringe (no crack) (FIG. 21A) and a cracked glass syringe (FIG. 21B), each bearing a standard opacity (89%) label (SCHREINER) and illuminated with green light (530 nm) from a lightbar, as shown in FIG. 17B.

The images shown in FIGS. 18-21 are acquired using a COGNEX Insight 8200M camera (S/N: 1A2151PP794002), and are processed using COGNEX In-Sight Explorer software and PatMax software tool. Magnification is not optimized, and PatMax software parameters are not optimized. Focus is on internal green box of previous “Crack Detection” images. Both IR and Green LED lightbar light sources appear to be feasible options for syringe crack detection beneath the white opaque and translucent portions of the standard opacity labels. With optimization of the PatMax software parameters, the software is capable of detecting syringe cracks beneath the white opaque and translucent portions of the standard opacity labels. More “noise” is observed with crack detection beneath the translucent portions of the label, which can be optimized within the software.

### Example 5: Camera Feasibility

Initial feasibility testing is performed with a COGNEX Insight 8200 camera for visual inspection and crack identification using axial (“down plunger rod”) illumination.

FIG. 22A illustrates a manual COGNEX camera green light setup. FIG. 22B illustrates an axially illuminated glass syringe bearing a standard opacity (89%) label and having cracks; FIG. 22C illustrates an axially illuminated glass syringe bearing a standard opacity (89%) label and having no cracks; FIG. 22D illustrates a backlit glass syringe bearing a standard opacity (89%) label and having cracks; and FIG. 22E illustrates a backlit glass syringe bearing a standard opacity (89%) label and having no cracks.

FIGS. 22B-22E suggest that axial lighting allows for effective inspection by image processing, while backlighting may cause false positive results when inspection is performed by processing images of the syringe(s). Further optimization may include testing of AI/machine learning algorithm.

FIGS. 23A-23D are images obtained using the system of FIG. 22A and processed as described above relative to FIGS. 22B-22E, of glass syringes bearing low-opacity (54%) labels (“Winpak single pass white test labels”). FIG. 23A illustrates an axially illuminated cracked glass syringe; FIG. 23B illustrates an axially illuminated glass syringe without cracks; FIG. 23C illustrates a backlit cracked glass syringe; and FIG. 23D illustrates a backlit glass syringe without cracks. Collectively, FIGS. 23A-23D illustrate that cracks show well under lower opacity labels and under axial illumination, but background light intensity is a challenge.

### Example 6: Visualization by Human Operators

Syringes bearing labels of two different opacities (standard opacity (89%) (SCHREINER) and low opacity (54%) (WINPAK) are evaluated with illumination by manual green pen light by three independent, blinded operators. Syringes labeled accordingly are placed in finger flange pucks or in clear trays and illuminated using an industrial grade lightbar. Each operator inspects each sample set, resulting in 95.556% overall detection of cracks with the standard opacity label, and 100% overall detection using low opacity labels.

### Example 7: Camera with Increased Edge Detection Software

Feasibility testing using a COGNEX Insight 8400 camera with included edge detection software and axial illumination proves capable of detecting cracks under the label. Further optimization is required.

### Example 8: Crack Detection in Vials

FIGS. 24A and 24B demonstrate the feasibility of using LED light to detect defects, e.g., cracks in glass vials in a manner similar to that described above with respect to glass syringes.

FIG. 24A illustrates a cracked glass vial bearing a standard opacity (89%) label on an exterior surface thereof, under ambient light conditions (FIG. 24A). The location of the crack is indicated by the oblong annotation on the image, but is undetectable, or substantially undetectable to the naked eye. FIG. 24B illustrates the same cracked glass vial, with the same label, illuminated axially with green LED light. The crack in the vial is readily visible through the label to the naked eye under axial green LED illumination, as indicated by the oblong annotation on the image.

### Embodiments

1. A method of inspecting a drug package comprising: illuminating the drug package using a light-emitting diode (LED) light source; and visually inspecting the drug package to determine a presence or an absence of a crack or defect therein, wherein illumination from the LED light source increases visibility of any cracks present in the drug package compared to ambient light.

2. The method of embodiment 1, wherein the drug package comprises glass.

3. The method of embodiment 1, wherein the drug package comprises a polymer material.

4. The method of embodiment 3, wherein the polymer material comprises a cyclic olefin copolymer (COC) or a cyclic olefin polymer (COP).

5. The method of embodiment 1, wherein the drug package comprises a primary container.

6. The method of embodiment 5, wherein the primary container comprises an ampoule, a cartridge, a vial, or a syringe.

7. The method of embodiment 5, wherein the primary container comprises a syringe having a plunger at least partially disposed within a barrel thereof.

8. The method of embodiment 1, wherein the drug package further comprises a label disposed thereon.

9. The method of embodiment 8, wherein the label comprises a substantially opaque label.

10. The method of embodiment 8, wherein the label comprises a transparent or translucent label.

11. The method of any one of embodiments 1-10, wherein the LED light source comprises white light.

12. The method of any one of embodiments 1-10, wherein the LED light source comprises green light.

13. The method of any one of embodiments 1-10, wherein the LED light source comprises infrared light.

14. The method of any one of embodiments 1-10, further comprising illuminating the drug package by backlighting the drug package with the LED light source.

15. The method of embodiment 14, wherein the LED light source comprises a light box.

16. The method of any one of embodiments 1-10, further comprising illuminating the drug package by axially illuminating the drug package with the LED light source.

17. The method of embodiment 16, wherein the LED light source comprises a lightbar.

18. The method of any one of embodiments 1-10, further comprising: using a camera to acquire an image of the drug package under illumination from the LED light source; and visually inspecting the drug package by processing the image on a computing device.

19. The method of embodiment 18, further comprising processing the image using a machine learning algorithm.

20. The method of any one of embodiments 1-10, further comprising inspecting a plurality of drug packages in a batch.

21. The method of embodiment 20, wherein the plurality of drug packages are disposed in a clear tray.

22. The method of any one of embodiments 1-10, further comprising conveying the drug package past the LED light source using a conveyor belt.

The embodiments of the disclosure beneficially facilitate the detection of cracks or defects in drug products that are difficult or impossible to visually identify using conventional inspection processes. Such drug packages include, e.g. fully assembled drug packages such as syringes, which include a plunger disposed within the barrel of the syringe and obscuring the ability to visually identify cracks and defects using conventional inspection techniques. Such drug packages may also include drug packages bearing a label on a surface thereof, which may further obscure conventional visual inspection of the drug package. Such drug packages may also include those that are both fully assembled as described herein, and bearing a label disposed on an outer surface thereof. While conventional visual inspection methods are challenged to effectively identify defects or cracks in such drug products, the present embodiments provide a method, apparatus, and system for effectively performing such inspection, and identifying cracks or defects as small as 1 mm.

While various embodiments are described herein, it will be appreciated from the specification that various combinations of elements, variations or improvements therein may be made by those skilled in the art, and are within the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of inspecting a drug package comprising:
illuminating the drug package using a light-emitting diode (LED) light source; and
visually inspecting the drug package to determine a presence or an absence of a crack or defect therein,
wherein illumination from the LED light source increases visibility of any cracks present in the drug package compared to ambient light.

2. The method of claim 1, wherein the drug package comprises glass.

3. The method of claim 1, wherein the drug package comprises a polymer material.

4. The method of claim 3, wherein the polymer material comprises a cyclic olefin copolymer (COC) or a cyclic olefin polymer (COP).

5. The method of claim 1, wherein the drug package comprises a primary container, the primary container comprising an ampoule, a cartridge, a vial, or a syringe.

6. The method of claim 5, wherein the primary container comprises a syringe having a plunger at least partially disposed within a barrel thereof.

7. The method of claim 1, wherein the drug package further comprises a label disposed thereon.

8. The method of claim 7, wherein the label comprises a substantially opaque label.

9. The method of claim 7, wherein the label comprises a transparent or translucent label.

10. The method of claim 1, wherein the LED light source comprises white light.

11. The method of claim 1, wherein the LED light source comprises green light.

12. The method of claim 1, wherein the LED light source comprises infrared light.

13. The method of claim 1, further comprising illuminating the drug package by backlighting the drug package with the LED light source.

14. The method of claim 13, wherein the LED light source comprises a light box.

15. The method of claim 1, further comprising illuminating the drug package by axially illuminating the drug package with the LED light source.

16. The method of claim 15, wherein the LED light source comprises a lightbar.

17. The method of claim 1, further comprising:
using a camera to acquire an image of the drug package under illumination from the LED light source; and
visually inspecting the drug package by processing the image on a computing device.

18. The method of claim 17, further comprising processing the image using a machine learning algorithm.

19. The method of claim 1, further comprising inspecting a plurality of drug packages in a batch, wherein the plurality of drug packages are disposed in a clear tray.

20. The method of claim 1, further comprising conveying the drug package past the LED light source using a conveyor belt.
